(19) United States
(12) Patent Application Publication
(10) Pub. No.: US 2026/0170264 A1
(43) Pub. Date: Jun. 18, 2026

(54) MULTIMODAL PROMPT GENERATION USING SMALL LANGUAGE MODELS

(71) Applicant: ADOBE INC., SAN JOSE, CA (US)

(72) Inventors: Yu-Chen Lin, Pittsburgh, PA (US); Sanat Sharma, Austin, TX (US); Jayant Kumar, San Jose, CA (US); Tracy Holloway King, Mountain View, CA (US); Hariharan Manikandan, San Jose, CA (US); Jing Zheng, San Jose, CA (US); Mayank Poddar, Santa Clara, CA (US); Harsha Vardhan Matada Allamaprabhu, Seattle, WA (US)

(21) Appl. No.: 18/985,961

(22) Filed: Dec. 18, 2024

(51) Int. Cl. G06F 40/40; G06F 40/30; G06T 11/00

(52) U.S. Cl. CPC G06F 40/40; G06F 40/30; G06T 11/00

(57) ABSTRACT

A method, apparatus, non-transitory computer readable medium, and system for generating synthetic asset includes obtaining an input prompt corresponding to a target element. An intent model is configured to generate an asset generation intent based on the input prompt, wherein the asset generation intent indicates the target element. Subsequently, a language model generates an asset generation prompt based on the asset generation intent, wherein the asset generation prompt describes the target element. An image generation model is used to generate a synthetic asset depicting the target element based on the asset generation prompt.

### BACKGROUND

The following generally relates to machine learning, and more specifically to asset generation using a machine learning model. Machine learning algorithms build a model based on sample data, known as training data, to make a prediction or a decision in response to an input without being explicitly programmed to do so. One area of application for machine learning is image generation.

For example, a machine learning model may be trained to predict information in response to an input prompt, and to then generate an output based on the predicted information. In some cases, the prompt can be used to perform a complex manipulation and compositing. The generated output provides for a user to edit or generate an image with desired features and therefore makes image generation easier for a layperson and also more readily automated.

### SUMMARY

The present disclosure describes systems and methods for multimedia processing, more specifically to a multimedia asset generation using an input prompt. Embodiments of the present disclosure include a multimedia processing apparatus configured to generate a multimedia asset (e.g., an image or a template) based on a user provided query. In some cases, the multimedia processing apparatus comprises an intent model for detection of an intent of the user provided query, a language model for generation of a detailed prompt based on the detected intent, and an image generation model for generation of the multimedia asset.

A method, apparatus, and non-transitory computer readable medium for natural language processing are described. One or more aspects of the method, apparatus, and non-transitory computer readable medium include obtaining an input prompt corresponding to a target element; generating, using an intent model, an asset generation intent based on the input prompt, wherein the asset generation intent indicates the target element; generating, using a language model, an asset generation prompt based on the asset generation intent, wherein the asset generation prompt describes the target element; and generating, using an image generation model, a synthetic asset depicting the target element based on the asset generation prompt.

A method, apparatus, and non-transitory computer readable medium for natural language processing are described. One or more aspects of the method, apparatus, and non-transitory computer readable medium include obtaining a training set including an asset generation intent and an asset generation prompt; combining the asset generation intent and the asset generation prompt to obtain an intermediate prompt; and training, using the training set, the language model to generate the asset generation prompt based on the intermediate prompt.

An apparatus and system for natural language processing are described. One or more aspects of the apparatus and system include at least one processor; at least one memory component coupled with the at least one processor; and a language model comprising parameters stored in the at least one memory component and trained to generate an asset generation prompt for generating a synthetic asset based on an asset generation intent.

### BRIEF DESCRIPTION OF THE DRAWINGS

FIG. 1 shows an example of a multimedia processing system according to aspects of the present disclosure.

FIG. 2 shows an example of a method for generating an asset according to aspects of the present disclosure.

FIG. 3 shows an example of a synthetic image generation process according to aspects of the present disclosure.

FIG. 4 shows an example of a synthetic template generation process according to aspects of the present disclosure.

FIG. 5 shows an example of a multimedia processing method according to aspects of the present disclosure.

FIG. 6 shows an example of a diffusion model according to aspects of the present disclosure.

FIG. 7 shows an example of a U-Net architecture according to aspects of the present disclosure.

FIG. 8 shows an example of a denoising diffusion process according to aspects of the present disclosure.

FIG. 9 shows an example of a method for multimedia processing according to aspects of the present disclosure.

FIG. 10 shows an example of a method for training a machine learning model according to aspects of the present disclosure.

FIG. 11 shows an example of an intent model according to aspects of the present disclosure.

FIG. 12 shows an example of a reinforcement learning process.

FIG. 13 shows an example of an upside down reinforcement learning process according to aspects of the present disclosure.

FIG. 14 shows an example of a method of training a machine learning model according to aspects of the present disclosure.

FIG. 15 shows an example of a diffusion network training according to aspects of the present disclosure.

FIG. 16 shows an example of a computing device according to aspects of the present disclosure.

FIG. 17 shows an example of a natural language processing apparatus according to aspects of the present disclosure.

FIG. 18 shows an example of a machine learning model according to aspects of the present disclosure.

### DETAILED DESCRIPTION

The present disclosure describes systems and methods for multimedia processing, more specifically to a multimedia asset generation using an input prompt. Embodiments of the present disclosure include a multimedia processing apparatus configured to generate a multimedia asset (e.g., an image or a template) based on a user provided query. In some cases, the multimedia processing apparatus comprises an intent model for detection of an intent of the user provided query, a language model for generation of a detailed prompt based on the detected intent, and an image generation model for generation of the multimedia asset.

Existing systems use diffusion-based methods for generation of images. For example, existing image generation systems may generate images or other multimedia items that do not include content as desired by users or may neglect an element of a user-provided prompt. As such, most existing systems are unable to capture each aspect of the prompt and hence do not align with the user-provided prompt. However, in order for such systems to generate images that align accurately with the associated text (e.g., input text prompt), a large amount of computational resources are needed. As a result, existing systems that are able to generate accurate images are constrained by a relatively low processing speed and high memory consumption. Therefore, there is a need in the art for a multimedia processing system that can perform image generation with increased accuracy and inference speed.

By contrast, embodiments of the present disclosure include a multimedia processing apparatus configured to generate a multimedia asset (e.g., an image or a template) that accurately aligns with each aspect of a user provided query. In some cases, the multimedia processing apparatus comprises an intent model for detection of an intent of the user provided query, a language model for generation of a detailed prompt based on the detected intent, and an image generation model for generation of the multimedia asset.

The present disclosure describes systems and methods for image processing, more specifically to multimedia asset generation based on an input query. According to an embodiment, a multimedia processing apparatus of the present disclosure includes a language model that generates a detailed (e.g., an effective) prompt based on the input query. Additionally, the multimedia processing apparatus includes an image generation model that uses the generated prompts for multi-tasking, i.e., to create a multimedia asset (e.g., an image, a template, etc.).

According to an embodiment, the multimedia asset generation can be implemented as a step-wise process. The multimedia processing apparatus includes an intent model configured to transform the input query to an asset generation prompt. In some cases, the intent model is configured to detect an asset generation intent based on the input query. For example, the input query is a unimodal or a multimodal query. In some examples, the input query is a search query, text in a template, a canvas, an image, a template, etc. For example, the asset generation intent is classified as a plurality of categorized intent terms including, but not limited to, topic, background, scene objects, action.

Additionally, the multimedia processing apparatus includes a language model configured to transform the detected asset generation intent into an asset generation prompt. For example, the language model is a compact version of a large language model (e.g., Llama-3) that is configured to generate the asset generation prompt using the asset generation intent. In some examples, the language model is trained using the large language model that generates a synthetic intent-to-prompt pair.

An embodiment of the present disclosure is configured to perform a distillation process that transfers knowledge from the large language model to the language model for a specific task. For example, the language model is trained using high-quality training data from the large language model to generate the asset generation prompt. In some examples, the language model is trained for tasks including, but not limited to, concept to intent detection, query to intent detection, prompt to intent detection.

In some cases, a prompt engineering pipeline is implemented to generate high-quality synthetic data. For example, embodiments of the present disclosure perform tasks such as crafting instructions and few-shot examples to generate a synthetic set of training data for a task. In some cases, the language model is trained to control a length of the asset generation prompt. In some cases, the language model is trained to control a content of the asset generation prompt. In some examples, the language model is trained to summarize the significant intents in a multimodal context.

An embodiment of the present disclosure includes the multimedia processing apparatus comprising the image generation model. In some cases, the image generation model is configured to generate a synthetic asset using the asset generation prompt. For example, the synthetic asset comprises an image or a template that is generated based on an asset category tag associated with the asset generation prompt. In some examples, the synthetic asset is the image that aligns with an input text query. In some examples, the synthetic asset is the template that aligns with an input canvas query.

Accordingly, by training the language model using the large language model, embodiments of the present disclosure are able to perform a knowledge distillation of the large language model for a specific task resulting in reduction of computational resources. Additionally, by training the language model, embodiments are able to ensure high-quality synthetic assets at a high inference speed while consuming significantly lower resources than any conventional image generation systems.

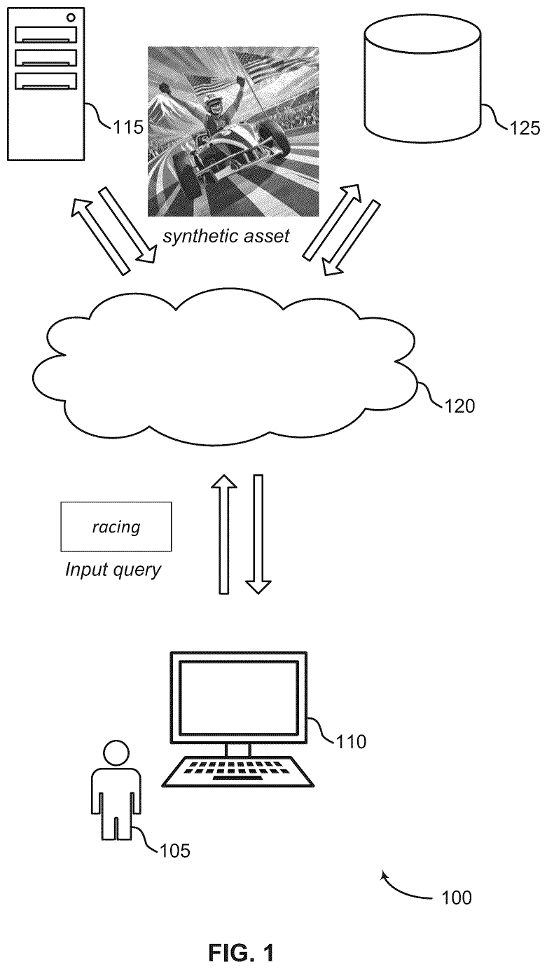

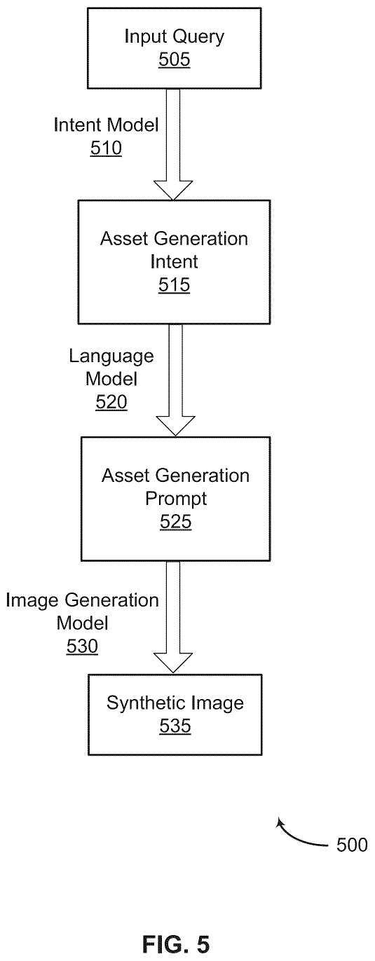

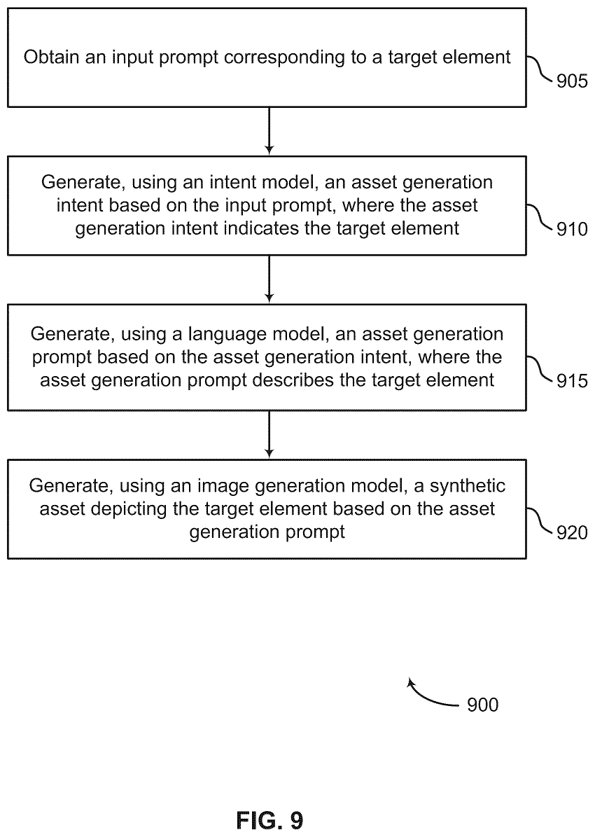

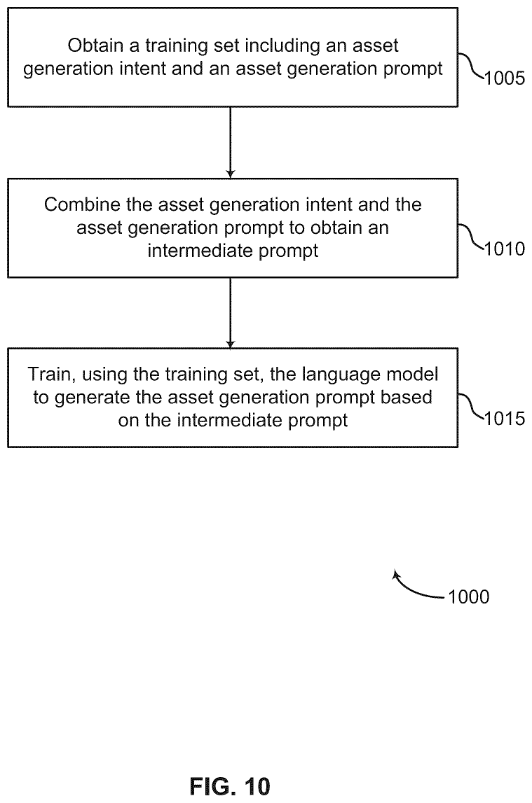

Embodiments of the present disclosure can be implemented in a multimedia processing system. For example, the multimedia processing system based on the present disclosure takes an input prompt (e.g., describing a target element) and generates an output that accurately depicts the element described in the prompt. Example applications regarding generating an output that depicts an element are provided with reference to FIGS. 1-4. Details regarding the architecture of the machine learning model are provided with reference to FIGS. 5-8 and 16-18. Details regarding an operation of the machine learning model are provided with reference to FIG. 9. Examples of a process for training the machine learning model are provided with reference to FIGS. 10-15.

### Multimedia Processing System

A system and an apparatus for multimedia processing are described with reference to FIGS. 1-8. FIG. 1 shows an example of a multimedia processing system 100 according to aspects of the present disclosure. In one aspect, multimedia processing system 100 includes user 105, user device 110, multimedia processing apparatus 115, cloud 120, and database 125.

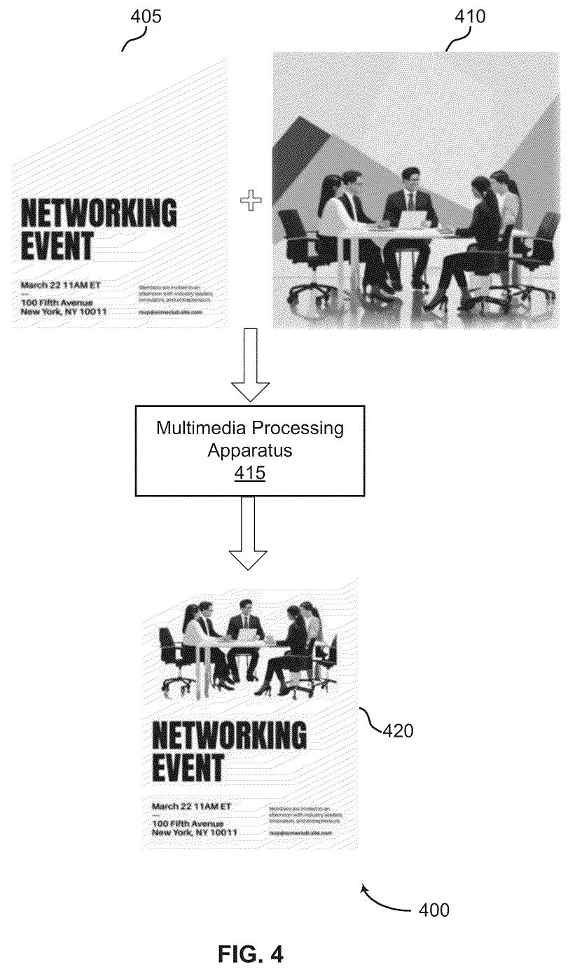

In the example of FIG. 1, user 105 provides a query with an element or an action (e.g., a verb such as “racing”) to multimedia processing apparatus 115 via a user interface provided on user device 110 by multimedia processing apparatus 115. In some examples, the input query is an input text (such as shown in FIGS. 1-3). In some examples, the input query is an input canvas (such as shown in FIG. 4). As shown in FIG. 1, the input prompt is a text that provides an action (e.g., “racing”) based on which the user wants to generate a synthetic image using the multimedia processing apparatus 115 of the present disclosure. According to some aspects, the multimedia processing apparatus 115 obtains an input prompt, i.e., describing an element.

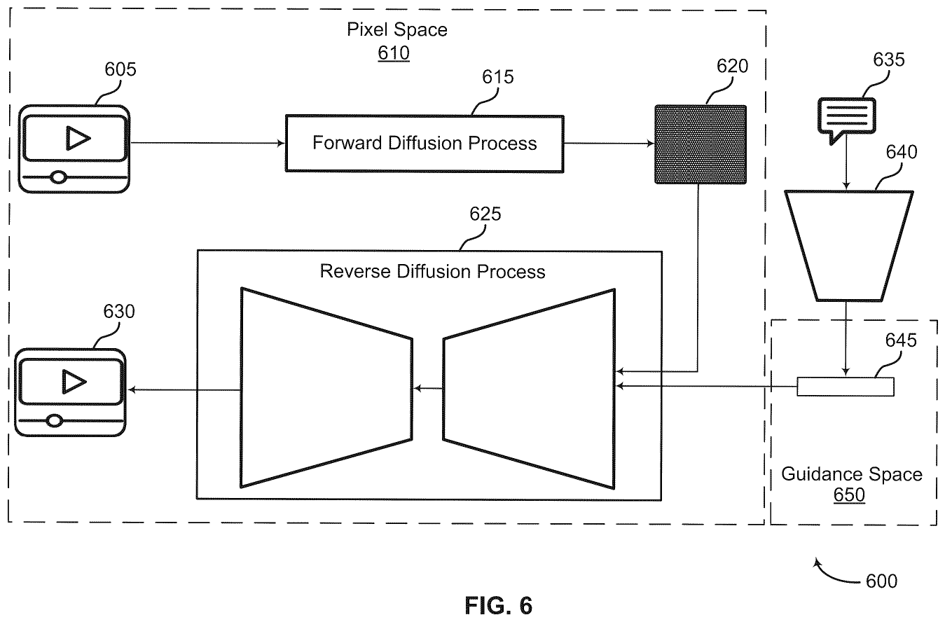

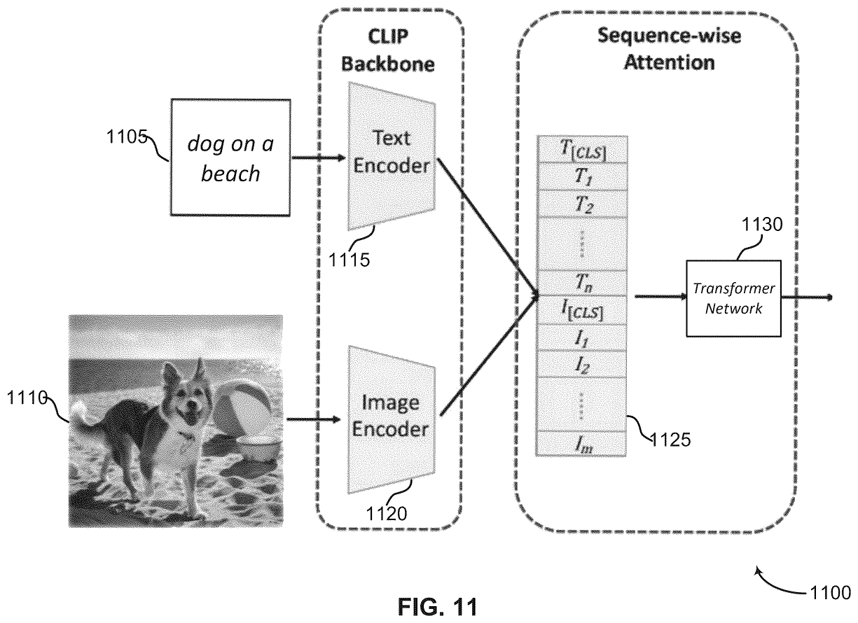

In some cases, the multimedia processing apparatus 115 implements an intent model (such as the intent model described with reference to at least FIG. 11), a language model (such as the language model described with reference to at least FIGS. 9-10 and 13), and an image generation model (such as the image generation model described with reference to at least FIGS. 6-8 and 15) to generate a synthetic asset that is based on the input prompt. In some cases, as shown in FIG. 1, the user provides an input query (e.g., a text prompt) to the multimedia processing apparatus 115, aspects of which the user wants to depict in the synthetic asset. In some examples, the multimedia processing apparatus generates a synthetic image that accurately aligns with the information provided by the input query.

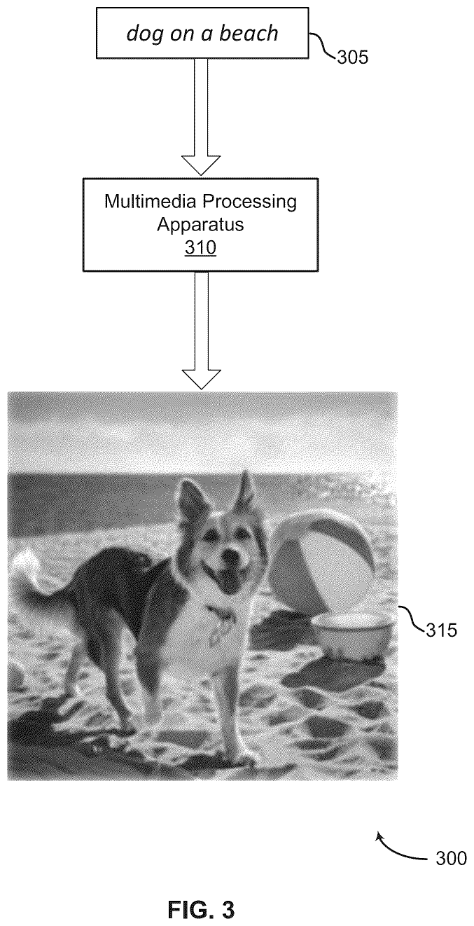

In some cases, the user provides an input query (e.g., a canvas as shown in FIG. 4) to the multimedia processing apparatus 115, aspects of which the user wants to depict in the synthetic asset. In some examples, the multimedia processing apparatus generates a synthetic template that accurately aligns with the information provided by the input canvas. Multimedia processing apparatus 115 is an example of, or includes aspects of, the corresponding element described with reference to FIGS. 3 and 4.

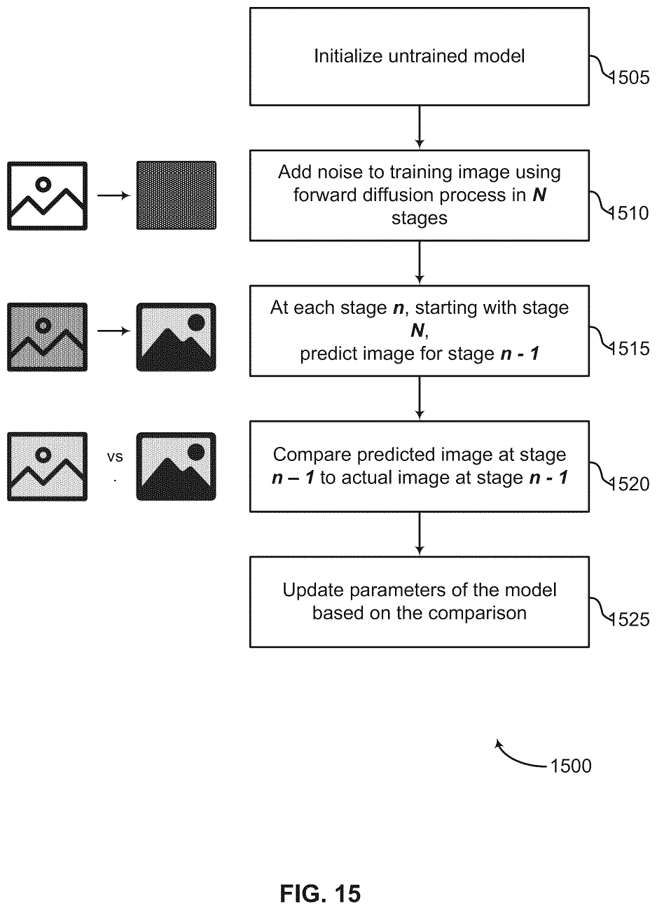

Referring again to the example of FIG. 1, the multimedia processing apparatus 115 generates the synthetic asset that accurately depicts (or further elaborates) each aspect (e.g., element) described by the input query. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by multimedia processing apparatus 115. In some aspects, the user interface provides for information (such as images (custom images or synthetic image), a prompt, a canvas, etc.) to be communicated between user 105 and multimedia processing apparatus 115. Multimedia processing apparatus 115 is an example of, or includes aspects of, the corresponding element described with reference to FIG. 15.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

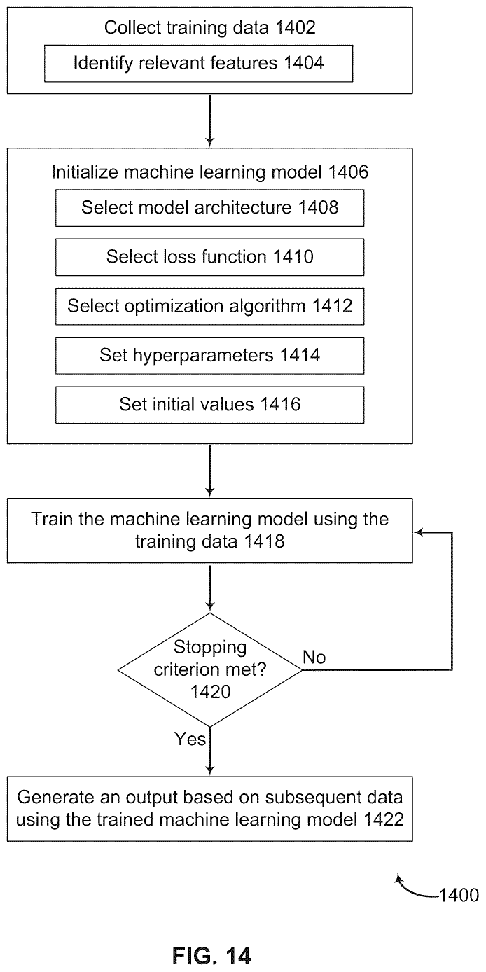

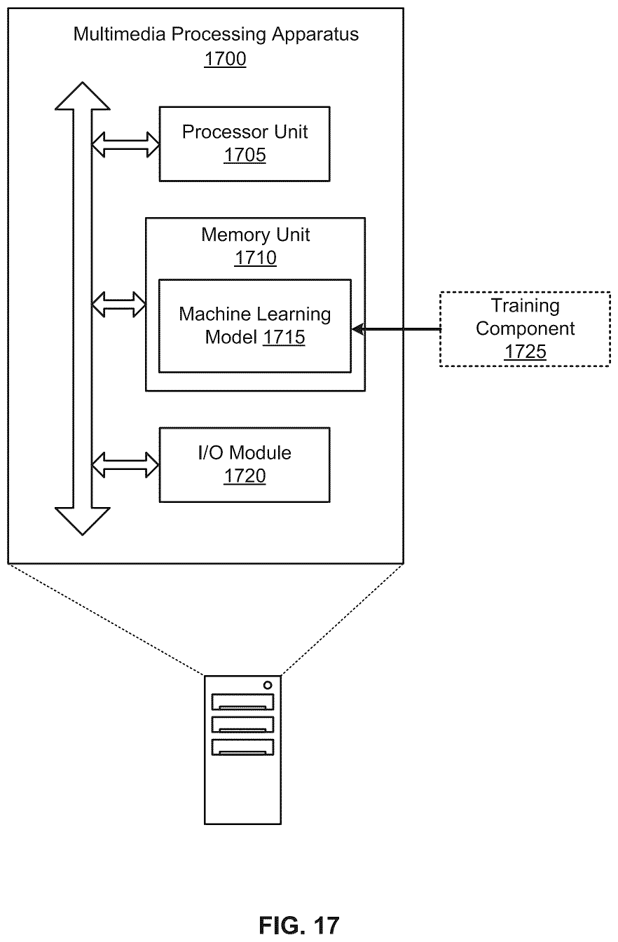

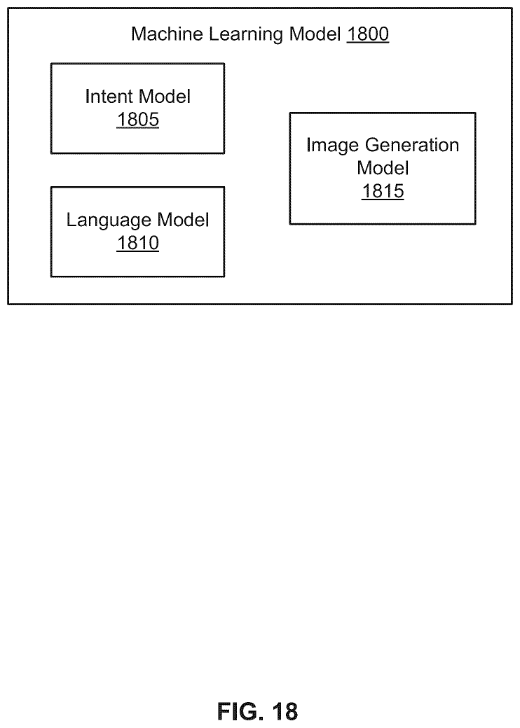

According to some aspects, multimedia processing apparatus 115 includes a computer-implemented network. In some embodiments, the computer-implemented network includes a machine learning model (such as the machine learning model described with reference to FIGS. 17-18). In some embodiments, multimedia processing apparatus 115 also includes one or more processors, a memory subsystem, a communication interface, an I/O interface, one or more user interface components, and a bus as described with reference to FIG. 14. Additionally, in some embodiments, multimedia processing apparatus 115 communicates with user device 110 and database 125 via cloud 120.

In some cases, multimedia processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, multimedia processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to multimedia processing apparatus 115 and communicates with multimedia processing apparatus 115 via cloud 120. According to some aspects, database 125 is included in multimedia processing apparatus 115.

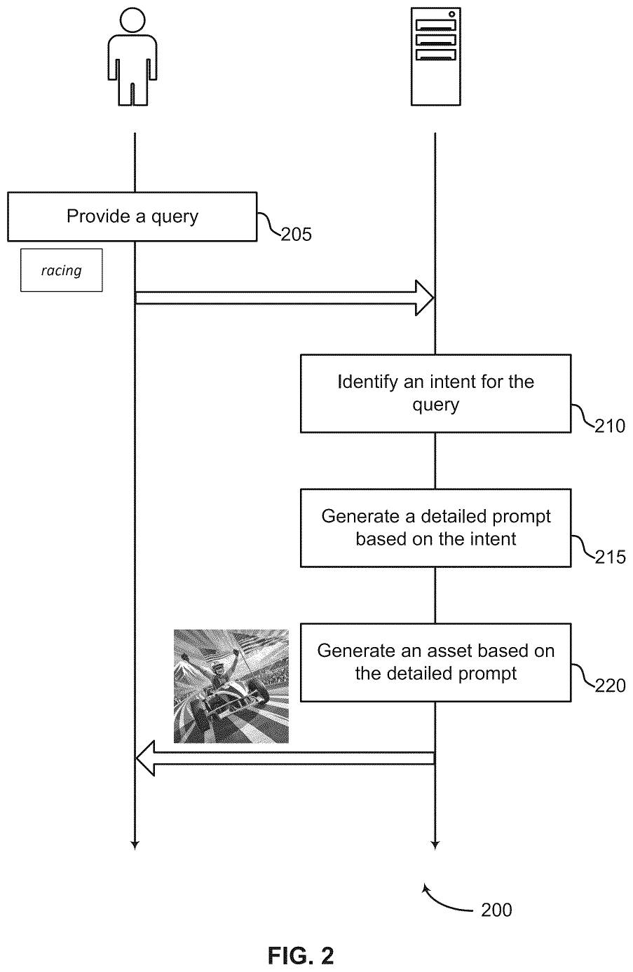

FIG. 2 shows an example of a method 200 for generating an asset according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

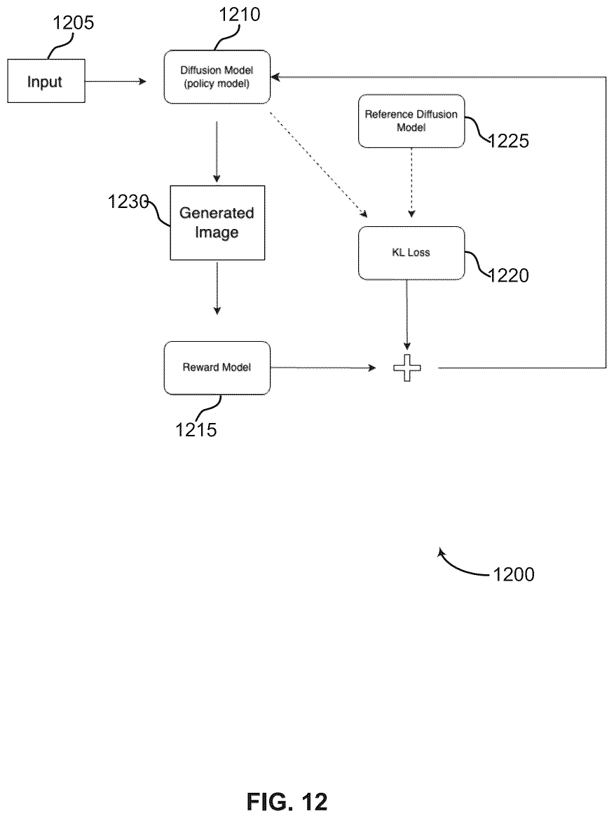

According to an embodiment of the present disclosure, a multimedia processing apparatus (such as the multimedia processing apparatus described with reference to FIGS. 3 and 12) provides a machine learning model (such as the machine learning model described with reference to FIGS. 17-18) that accurately generates a synthetic asset depicting the element described in the input query.

At operation 205, the system provides a query. In some cases, the operations of this step refer to, or may be performed by, a user as described with reference to FIG. 1. Additionally, the user provides a prompt to the multimedia processing apparatus. In some cases, the query is a text prompt that provides an element based on which the user wants to generate an image. For example, the user provides an input query instructing the multimedia processing apparatus to generate an image that corresponds to the “racing” query.

At operation 210, the system identifies an intent for the query. In some cases, the operations of this step refer to, or may be performed by, a multimedia processing apparatus as described with reference to FIG. 17.

In some cases, the multimedia processing apparatus includes a machine learning model comprising an intent model that is configured to identify an intent of the query. For example, the intent model is configured to identify an intent (categorized such as topics, backgrounds, scene objects, and actions) for a multimodal input query. In some examples, the intent model identifies the categorized intent terms such as “racing car”, “cheering and waving flags”, “bright and sunny background”, etc. corresponding to the “racing” query. Further details regarding this operation are provided with reference to at least FIG. 11.

At operation 215, the system generates a detailed prompt based on the intent. In some cases, the operations of this step refer to, or may be performed by, a multimedia processing apparatus as described with reference to FIG. 17.

In some cases, the multimedia processing apparatus includes a machine learning model comprising a language model that is configured to provide a detailed prompt for the received query based on the identified intent. For example, for the query “racing” shown in FIG. 2, the language model is able to generate a more detailed prompt such as “a racing car crossing the finish line, with a racing team cheering and waving flags, set against a bright and sunny background with cheering crowds” based on the intent identified at operation 210. Further details regarding this operation are provided with reference to at least FIGS. 5, 9-10 and 13.

At operation 220, the system generates an asset based on the detailed prompt. In some cases, the operations of this step refer to, or may be performed by, a multimedia processing apparatus as described with reference to FIG. 17.

In some cases, the multimedia processing apparatus includes a machine learning model comprising an image generation model that is configured to generate a synthetic asset (e.g., a synthetic image or synthetic template as described with reference to FIGS. 3-4) based on the detailed prompt for the query obtained in operation 215. In some cases, the multimedia processing apparatus uses the prompt to generate the synthetic asset for the search query to generation use case. For example, the synthetic asset is generated using an image generation model as described with reference to at least FIGS. 6-8. The synthetic image is provided to the user via a user interface of the user device.

FIG. 3 shows an example of a synthetic image generation process 300 according to aspects of the present disclosure. In one aspect, synthetic image generation process 300 includes input query 305, multimedia processing apparatus 310, and synthetic image 315.

Referring to FIG. 3, input query 305 describes aspects of an image a user (such as the user described with reference to FIGS. 1-2) wants to generate. For example, the user wants to generate an image with a “dog on a beach”. In some examples, the user provides input query 305 to multimedia processing apparatus 310 via a user interface of the multimedia processing apparatus 310. Input query 305 is an example of, or includes aspects of, the corresponding element described with reference to FIGS. 1-2 and 4.

The multimedia processing apparatus 310 (such as the multimedia processing apparatus described with reference to FIGS. 1-2, 5, 9-10, and 17) of the present disclosure receives the input query 305 (such as input query described with reference to FIGS. 1-2) from the user. In some cases, the multimedia processing apparatus 310 generates synthetic image 315 that matches aspects of the input prompt 305.

In some cases, the multimedia processing apparatus 310 implements language model (such as language model described with reference to FIGS. 5, 9-10, and 13) to generate a descriptive prompt such as “a happy dog walking on a sunny beach, set against a warm, sandy background, with a few beach balls and towels scattered around” corresponding to the input query 305 of a “dog on a beach”.

Subsequently, the multimedia processing apparatus 310 generates synthetic image 315 that accurately depicts a “dog on a beach” based on the descriptive prompt associated with input query 305. Multimedia processing apparatus 310 is an example of, or includes aspects of, the corresponding element described with reference to FIGS. 1 and 4. Synthetic image 315 is an example of, or includes aspects of, the corresponding element described with reference to FIGS. 5 and 11.

FIG. 4 shows an example of a synthetic template generation process 400 according to aspects of the present disclosure. In one aspect, synthetic template generation process 400 includes input query 405, image 410, multimedia processing apparatus 415, and synthetic template 420.

Referring to FIG. 4, input query 405 describes aspects of a template a user (such as the user described with reference to FIGS. 1-2) wants to generate. For example, the user wants to generate a template corresponding to a canvas received as input query 405 (as shown in FIG. 4). In some examples, the user provides input query 405 to multimedia processing apparatus 415 via a user interface of the multimedia processing apparatus 415. Additionally, for example, the user wants to generate a template corresponding to image 410 (as shown in FIG. 4). In some examples, the user provides image 410 to multimedia processing apparatus 415 via a user interface of the multimedia processing apparatus 415. Input query 405 is an example of, or includes aspects of, the corresponding element described with reference to FIGS. 3 and 5.

The multimedia processing apparatus 415 (such as the multimedia processing apparatus described with reference to FIGS. 1-2, 5, 9-10, and 17) of the present disclosure receives the input query 405 (such as input query described with reference to FIGS. 1-2) from the user. The multimedia processing apparatus 415 captures the text of the canvas (query 405) in the synthetic template 420. Additionally, the multimedia processing apparatus 415 performs style transfer of the canvas (query 405) to generate the synthetic template 420.

In some cases, the multimedia processing apparatus 415 implements a language model (such as language model described with reference to FIGS. 5, 9-10, and 18) to generate a descriptive prompt based on the query 405 (e.g., source canvas). For example, the language model generates descriptive prompt “a bold, colorful image of a networking workshop, featuring a large, collaborative workspace, with attendees from diverse backgrounds working together, set against a vibrant, abstract background with shapes and patterns” corresponding to input query 405.

In some cases, the multimedia processing apparatus 415 generates synthetic template 420 that closely matches aspects (e.g., style, text) of the input query 405 and incorporates image 410. For instance, the multimedia processing apparatus 415 generates synthetic template 420 that accurately depicts an asset based on the input query 405 and image 410. Multimedia processing apparatus 415 is an example of, or includes aspects of, the corresponding element described with reference to FIGS. 1 and 3. Synthetic template 420 is an example of, or includes aspects of, the corresponding element described with reference to FIGS. 5 and 11.

According to an exemplary embodiment, the multimedia processing apparatus (such as described herein) generates a variation in the template (such as synthetic template 420). In some cases, the multimedia processing apparatus is configured to replace the foreground object and background directly of the image (such as image 410). For example, as shown in FIG. 4, the background of image 410 is replaced when incorporating the object (e.g., group of people sitting at a table shown in image 410) into the canvas (e.g. input query 405). Thus, the synthetic template 420 depicts the same style as the input query 405.

FIG. 5 shows an example of a multimedia processing method 500 according to aspects of the present disclosure. In one aspect, multimedia processing method 500 includes input query 505, asset generation intent 515, asset generation prompt 525, and synthetic image 535.

According to an embodiment, the multimedia processing method 500 is performed using machine learning model (such as machine learning model described with reference to FIG. 17). In some cases, the machine learning model includes intent model (such as intent model 510), language model (such as language model 520), an image generation model (such as image generation model 530) as described with reference to FIG. 18.

As shown in FIG. 5, user provides input query 505. In some examples, input query 505 is a multimodal input. In some examples, input query 505 is a query, text, canvas, or asset (e.g., image, template). Input query 505 is an example of, or includes aspects of, the corresponding element described with reference to FIGS. 3 and 4.

The intent model is implemented to detect a user intent categorized as a topic, a background, a scene object, and an action from the input query 505 (e.g., multimodal input). In some cases, the intent model generates an asset generation intent 515 based on the input query 505. Intent model 510 is an example of, or includes aspects of, the corresponding element described with reference to FIG. 11. Asset generation intent 515 is an example of, or includes aspects of, the corresponding element described with reference to at least FIGS. 9-10 and 13.

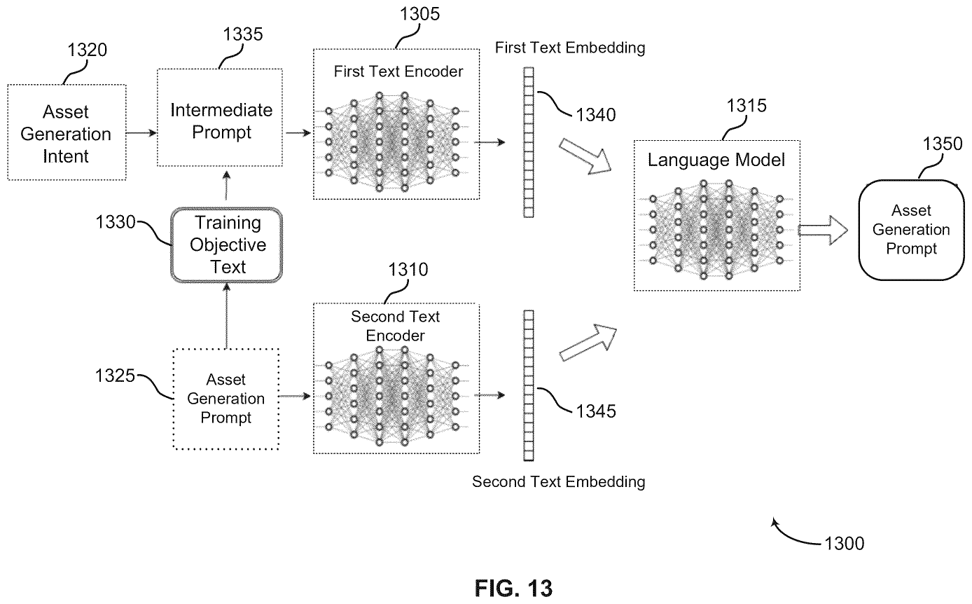

The language model 520 is configured to generate asset generation prompt 525 such as image prompt or a template prompt based on the asset generation intent 515. In some cases, the language model 520 is able to precisely control a length of the asset generation prompt. Language model 520 is an example of, or includes aspects of, the corresponding element described with reference to FIG. 13. Asset generation prompt 525 is an example of, or includes aspects of, the corresponding element described with reference to FIG. 13. Further details regarding generation of the asset generation prompt are provided with reference to FIGS. 9-10 and 13.

The image generation model is configured to generate synthetic asset (such as synthetic image 535) based on the asset generation prompt 525. In some cases, the asset generation prompt 525 is used for a contextual pretrained transformer (CPT). Synthetic image 535 is an example of, or includes aspects of, the corresponding element described with reference to FIGS. 3 and 11. Image generation model 530 is an example of, or includes aspects of, the corresponding element described with reference to FIGS. 6-8 and 15. Further details regarding generation of the synthetic asset are provided with reference to FIGS. 6-8 and 15.

A CPT is a deep learning model architecture that leverages the power of transformers, specifically attention mechanisms, to understand and generate contextually relevant language. CPTs utilize a stack of transformer layers, each containing self-attention and feed-forward neural networks. The self-attention mechanism enables the model to weigh and capture relationships between words in a sequence, allowing it to understand context and semantic nuances. CPTs are pretrained on large corpora using masked language modeling (MLM), where parts of the text are masked, and the model learns to predict the missing tokens based on context. This pretraining enables CPTs to capture general linguistic knowledge, which can be fine-tuned on specific tasks, such as text classification, summarization, or question-answering. CPTs differ from traditional transformers in that they emphasize contextual understanding and adapt dynamically to varying sentence structures and topics.

FIG. 6 shows an example of a guided diffusion model 600 according to aspects of the present disclosure. In some examples, guided diffusion model 600 describes the operation and architecture of the image generation model 1815 described with reference to FIG. 18. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 7, 8, 12, and 14-16.

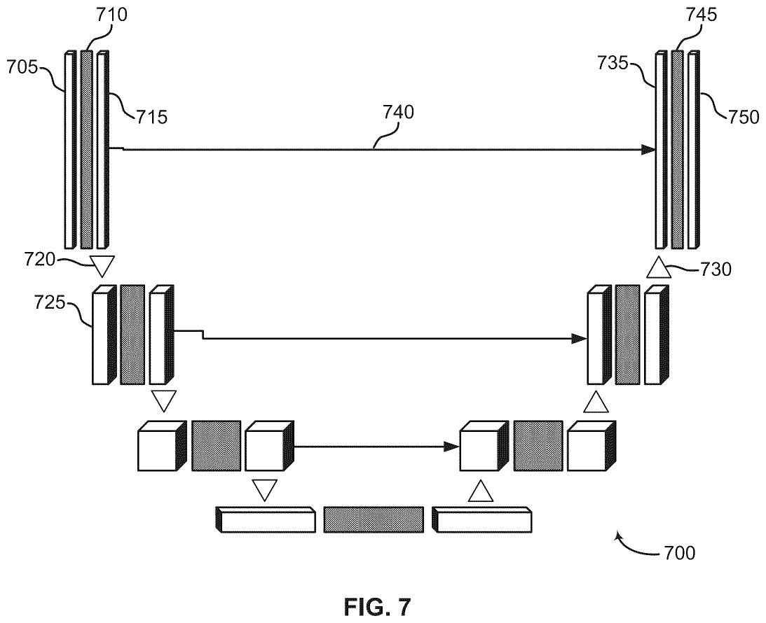

FIG. 7 shows an example of a U-Net 700 according to aspects of the present disclosure. In some examples, U-Net 700 is an example of the component that performs the reverse diffusion process 625 of guided diffusion model 600 described with reference to FIG. 6 and includes architectural elements of the image generation model 1815 described with reference to FIG. 18. The U-Net 700 depicted in FIG. 7 is an example of, or includes aspects of, the architecture used within the reverse diffusion process described with reference to FIG. 6.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having the same resolution and number of channels via a skip connection 740. These inputs are processed using a final neural network layer 745 to produce output features 750. In some cases, the output features 750 have the same resolution as the initial resolution and the same number of channels as the initial number of channels.

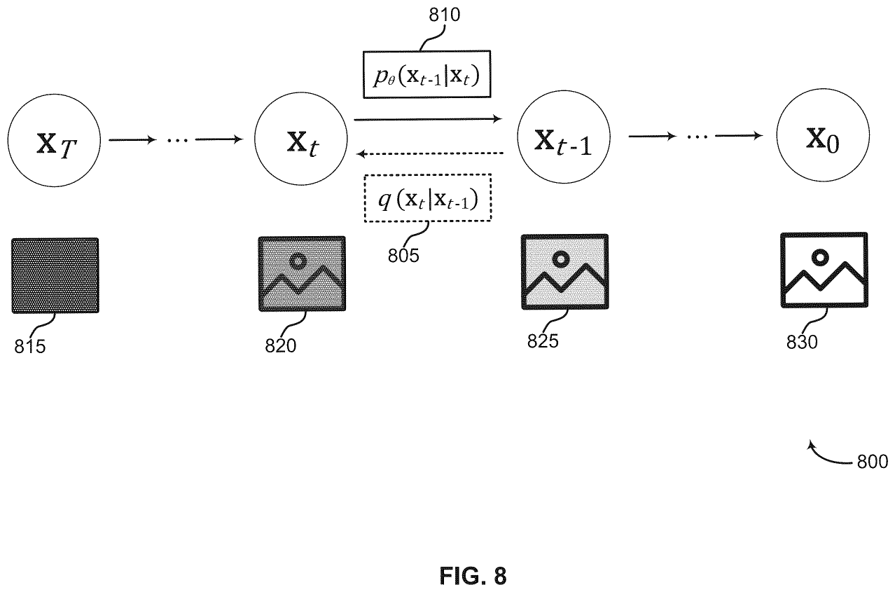

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715. U-Net architecture is an example of, or includes aspects of, the corresponding element described with reference to FIGS. 6 and 8.

FIG. 8 shows a diffusion process 800 according to aspects of the present disclosure. In some examples, diffusion process 800 describes an operation of the machine learning model 1715 described with reference to FIG. 17 or machine learning model 1800 described with reference to FIG. 18, such as the reverse diffusion process 625 of guided diffusion model 600 described with reference to FIG. 6.

As described above with reference to FIG. 6, using a diffusion model can involve both a forward diffusion process 805 for adding noise to a media item (or features in a latent space) and a reverse diffusion process 810 for denoising the media item (or features) to obtain a denoised media item. The forward diffusion process 805 can be represented as q(xₜ|xₜ₋₁), and the reverse diffusion process 810 can be represented as q(xₜ₋₁|xₜ). In some cases, the forward diffusion process 805 is used during training to generate media items with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data x_{T}, such as a noisy media item 815 and denoises the data to obtain the p(xₜ₋₁|xₜ). At each step t−1, the reverse diffusion process 810 takes xₜ, such as first intermediate media item 820, and t as input. Here, t represents a step in the sequence of transitions associated with different noise levels, The reverse diffusion process 810 outputs xₜ₋₁, such as second intermediate media item 825 iteratively until x_{T} reverts back to x₀, the original media item 830. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t - 1}^{T} {p}_{θ} ( {x}_{t - 1} \vert {x}_{t} ) \qquad ( 2 )$$

where p(x)=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 6-7, 15, and 18.

Accordingly, an apparatus for multimedia processing is described. One or more aspects of the apparatus include at least one processor; at least one memory component coupled with the at least one processor; and a language model comprising parameters stored in the at least one memory component and trained to generate an asset generation prompt for generating a synthetic asset based on an asset generation intent.

Some examples of the apparatus and system further include an intent model configured to generate the asset generation intent based on an input prompt. Some examples of the apparatus and system further include an image generation model configured to generate the synthetic asset depicting based on the asset generation prompt.

In some aspects, the language model is trained using upside-down reinforcement learning. In some aspects, the language model is trained by distilling a teacher model.

### Multimedia Generation Process

The present disclosure describes systems and methods for multimedia asset generation. Embodiments of the present disclosure are configured to generate a synthetic asset that accurately aligns with an element of the query provided as input. In some cases, the synthetic asset is generated based on a descriptive prompt generated based on the input query.

In some cases, when a user inputs a search query, a multimedia processing apparatus of the present disclosure retrieves relevant assets, such as images or templates, based on user input (e.g., text input). For example, the user uses recommendations for additional components (e.g., background, objects, etc.) that can be incorporated into the synthetic asset (e.g., synthetic image or synthetic template).

According to an embodiment of the present disclosure, the multimedia processing apparatus comprises a machine learning model including a language model that is configured to generate descriptive text corresponding to an input query. For example, the language model is based on an upside-down reinforcement learning process (such as upside-down reinforcement learning process described with reference to FIG. 13) and is generated by performing a knowledge distillation of a large language model (e.g., Llama-3).

FIG. 9 shows an example of a method 900 for multimedia processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains an input prompt corresponding to a target element. In some cases, the operations of this step refer to, or may be performed by, a user interface as described with reference to FIGS. 1-2 and 16-17.

For example, in some cases, the user interface of the multimedia processing apparatus (such as multimedia processing apparatus 1700 described with reference to FIG. 17) receives an input prompt from a user. In some examples, the input prompt is a text prompt that describes an element that the user wants to depict in the generated asset (e.g., synthetic asset). In some examples, the multimedia processing apparatus receives the input prompt from a database or any other data source.

At operation 910, the system generates, using an intent model, an asset generation intent based on the input prompt, where the asset generation intent indicates the target element. In some cases, the operations of this step refer to, or may be performed by, an intent model as described with reference to FIGS. 11 and 18.

In some cases, an intent model of the machine learning model is configured to extract an asset generation intent of the user based on the input prompt. An exemplary embodiment of the present disclosure includes use of a knowledge graph that comprises relationships between different user intents. In some examples, the related edges are used as the first source. According to an exemplary embodiment, the intent model is used to label each template with an asset generation intent. In some examples, the intent model is configured to evaluate the asset generation intent for each template based on a confidence value and uses templates with a high confidence value.

For example, in case of a given input template, the intent model classifies the asset generation intent as a topic (e.g., holiday discount) and a scene object (e.g., holiday sale). Additionally, for example, in case of a given input image, the intent model classifies the asset generation intent as a topic (e.g., t-shirt print), a design type (e.g., t-shirt), an icon (e.g., t-shirt icon), an action (e.g., looking cool), a background (e.g., blank shirt background), and a scene object (e.g., t-shirt print). Further details regarding generation of an asset generation intent using the intent model are provided with reference to at least FIGS. 2-4 and 10-11.

At operation 915, the system generates, using a language model, an asset generation prompt based on the asset generation intent, where the asset generation prompt describes the target element. In some cases, the operations of this step refer to, or may be performed by, a language model as described with reference to FIG. 18.

According to an embodiment, the language model of the present disclosure is a small-scale language model. In some cases, the language model is trained based on distilling knowledge from a large language model (e.g., Llama-3) for a specific task. For example, the large language model is used to generate training data (e.g., synthetic training data) based on the asset generation intent (generated at operation 910). In some examples, the large language model generates the synthetic training data (i.e., an intermediate prompt) that defines aspects of the asset generation prompt.

For example, the intermediate prompt comprises a tag (or e.g., a plurality of tags) that defines a length (e.g., a number of tokens), intent, type of prompt to be generated (e.g., image prompt, template prompt, etc.) that define the asset generation prompt. In some cases, the intermediate prompt is used to train the language model to generate the asset generation prompt. Further details regarding this operation are provided with reference to at least FIGS. 10 and 13.

At operation 920, the system generates, using an image generation model, a synthetic asset depicting the target element based on the asset generation prompt. In some cases, the operations of this step refer to, or may be performed by, an image generation model as described with reference to FIG. 18.

The image generation model generates the synthetic asset that depicts the element indicated by the input prompt. For example, the image generation model generates an image or a template based on the tag (i.e., a <prompt_type> tag) associated with the asset generation prompt. In some cases, the synthetic asset is generated via a diffusion process based on the asset generation prompt as described with reference to FIGS. 6-8 and 14-15. In some cases, the image generation model provides the synthetic asset to the user via the user interface (such as the user interface described with reference to at least FIGS. 1-3).

Accordingly, a method for multimedia processing is described. One or more aspects of the method include obtaining an input prompt corresponding to a target element; generating, using an intent model, an asset generation intent based on the input prompt, wherein the asset generation intent indicates the target element; generating, using a language model, an asset generation prompt based on the asset generation intent, wherein the asset generation prompt describes the target element; and generating, using an image generation model, a synthetic asset depicting the target element based on the asset generation prompt.

In some aspects, the input prompt comprises a multimodal asset including a text element and an image element. In some aspects, the asset generation intent comprises a plurality of categorized intent terms including a topic intent, a background intent, an action intent, a scene intent or a combination thereof.

Some examples of the method, apparatus, and non-transitory computer readable medium further include generating the asset generation prompt comprises: determining an intermediate prompt including the asset generation intent and an intent tag, wherein the asset generation prompt is generated based on the intermediate prompt.

Some examples of the method, apparatus, and non-transitory computer readable medium further include generating the asset generation prompt comprises: determining an intermediate prompt including a target prompt length, wherein the asset generation prompt is generated based on the intermediate prompt.

Some examples of the method, apparatus, and non-transitory computer readable medium further include generating the asset generation prompt comprises: determining an intermediate prompt including an asset category tag, wherein the asset generation prompt is generated based on the intermediate prompt, and wherein the synthetic asset comprises an asset category corresponding to the asset category tag.

In some aspects, the synthetic asset comprises a multimodal asset including a synthetic image depicting the target element and a text element. In some aspects, the language model is trained using upside-down reinforcement learning based on a training intermediate prompt that includes a training asset generation intent and a training asset generation prompt.

### Training

The present disclosure describes systems and methods for generation of a multimedia asset. Embodiments of the present disclosure include a multimedia processing apparatus comprising a machine learning model configured to receive an image, a text, or a multimodal input from a user and generate a personalized template recommendation based on the user-provided input. In some cases, the machine learning model provides the user with a recommendation based on a generative template.

An embodiment of the present disclosure includes a training component configured to train the machine learning model. In some cases, the training component uses a large language model (e.g., Llama-3) to generate a synthetic intent-to-prompt pair. In some cases, the large language model (e.g., Llama-3) is used to train the machine learning model (i.e., a language model of the machine learning model) by performing knowledge distillation using an upside-down reinforcement learning method (as described in FIG. 13). By using the large language model to train the machine learning model of the present disclosure, embodiments are able to ensure high-quality training data via clear instructions and few-shot examples.

In some cases, the trained machine learning model is used to generate an effective asset generation prompt for generating an image and/or a template for a given (e.g., multimodal or unimodal) query such as search query, text in a template, canvas, image, template, etc. In some cases, the trained machine learning model is used to generate a synthetic asset based on the generated asset generation prompt.

FIG. 10 shows an example of a method 1000 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. Further details regarding each of the operations 1005-1015 are provided with reference to FIG. 13.

At operation 1005, the system obtains a training set including an asset generation intent and an asset generation prompt. In some cases, the operations of this step refer to, or may be performed by, a training component as described with reference to FIG. 17.

In some cases, the machine learning model includes an intent model configured to generate an asset generation intent for the user-provided input. Based on the asset generation intent, the training component is configured to generate a high-quality prompt template for a large language model to generate accurate intent-prompt pairs. In some cases, the training component is used to provide details to the large language model regarding a structure of an asset generation prompt. In some cases, the training component is used to provide the large language model with details regarding variations in the asset generation prompt.

The training component provides the large language model with a concept (or a plurality thereof), a corresponding prompt snippet and an explanation for generating the asset generation prompt. For example, the training component provides the large language model with a concept (e.g., “High level task descriptions”), a prompt snippet (e.g., “Generate the prompts for text-to-<prompt_type> generative models given the concepts”), and an explanation (e.g., “In the beginning, we tell the model what kind of prompt we want to generate”). Additionally, the training component provides a “Definition of a good prompt” as another concept for a prompt snippet (e.g., “A good prompt should align precisely with the given concepts, avoiding the introduction of unrelated ideas, and be clear, descriptive, creative, and positive”) and corresponding explanation (e.g., “This part gives the Llama-3 some core requirements of the generated prompt and can be modified into different use cases”).

Similarly, the training component provides another concept (e.g., “Few-shot examples”), a corresponding prompt snippet (e.g., “For example, [concepts] Topic: birthday [[prompts]] 1. Colorful birthday celebration with balloons, cake, and happy children playing in a sunny park. 2. Elegant birthday dinner with candles, flowers, and a beautifully decorated cake on the table . . . ”), and an explanation (e.g., “Examples are essential. We used GPT-4o to generate these examples. In total, we provided 5 intents, each with 2 prompts”).

Additionally, the training component provides a concept (e.g., “Detailed task descriptions”), a corresponding prompt snippet (e.g., “Now, complete the following by generating 10 prompts for <prompt_type> generation given the specified concepts, using the examples given above as a guide.”), and an explanation (e.g., “We informed the Llama-3 again what our task is and asked it to follow the examples given”). Further, training component provides another concept (e.g., “Variations and diversity between prompts”), a corresponding prompt snippet (e.g., “Make sure that the 10 prompts encompass a range of variations and exhibit diversity”), and an explanation (e.g., “We want to generate a diverse set of data. It would be better to prompt Llama-3 to generate variations of prompts”).

Additionally, the training component provides a concept (e.g., “Formatting”), a corresponding prompt snippet (e.g., “Please ensure that the resulting output consists solely of a numbered list of prompts, mirroring the format provided in the examples. Refrain from including any additional introductory or concluding texts, strictly adhering to the specified output format”), and an explanation (e.g., “This part would be useful for post-processing the prompts we generated. We have not tried Json formatting, but the prompt can be easily modified to achieve it”). Further, training component provides another concept (e.g., “Prompt for Generation”), a corresponding prompt snippet (e.g., “[[concepts]] topic: abstract floral [[prompts]]”), and an explanation (e.g., “The last part would be providing the intents and asking Llama-3 to complete the template. The format should be the same as the examples given”).

At operation 1010, the system combines the asset generation intent and the asset generation prompt to obtain an intermediate prompt. In some cases, the operations of this step refer to, or may be performed by, a training component as described with reference to FIG. 18.

An embodiment of the present disclosure is configured to perform data generation using a large language model. For example, the large language model is Llama-3 with virtual large language model (i.e., vLLM). In some examples, vLLM is able to accelerate the inference speed. In some examples, the large language model is configured to generate an intermediate prompt using the asset generation intent (such as topic, scene object, etc. as described with reference to FIGS. 9 and 11) and the asset generation prompt (as described in at least operation 1005). In some cases, the intermediate prompt is used to train the language model (i.e., a small-scale language model) as described in operation 1015.

In some cases, the training component is configured to generate a format of an intermediate prompt (e.g., “<|19|> <|intent|> Topic: birthday, Scene object: balloon <|IP|> whimsical birthday celebration featuring giant balloons in fun shapes and sizes, tied to a birthday child's arm or wrist”) based on combining an asset generation prompt (e.g., “(prompt for image gen.) whimsical birthday celebration featuring giant balloons in fun shapes and sizes, tied to a birthday child's arm or wrist”) and an asset generation intent (“Topic: birthday; Scene object: balloon”).

Similarly, the training component is configured to generate a format of another intermediate prompt (e.g., “<|14|> <|intent|> Topic: birthday party, Design Type: invitation <|TP|> create a whimsical birthday party invitation template with balloons, confetti, and a playful theme”) based on combining an asset generation intent (e.g., “Topic: birthday party; Design type: invitation”) and an asset generation prompt (“(prompt for template gen.) create a whimsical birthday party invitation template with balloons, confetti, and a playful theme”).

At operation 1015, the system trains, using the training set, the language model to generate the asset generation prompt based on the intermediate prompt. In some cases, the operations of this step refer to, or may be performed by, a training component as described with reference to FIG. 17.

In some examples, the training component trains the language model based on the intermediate prompt (i.e., intermediate prompt is used as an input to the language model). Based on the intermediate prompt (as described in operation 1010), the training component instructs the language model to generate an asset generation prompt of a specified length (e.g., 19 tokens or 14 tokens as illustrated in operation 1010). Additionally, the intermediate prompt provides information regarding the type of synthetic asset to be generated based on the type of prompt, e.g., <IP> indicates an image prompt and <TP> indicates a template prompt.

Accordingly, the language model generates an asset generation prompt based on training using the intermediate prompt. In some cases, the language model is trained using intermediate prompt generated by the large language model that defines aspects including, but not limited to, the length, the prompt type (e.g., <IP> or <TP> corresponding to image or template, respectively), the asset generation intent, etc, for the asset generation prompt. Further details regarding generation of the synthetic asset including an image or a template are provided with reference to FIGS. 6-9. Further details regarding training the language model by performing knowledge distillation of a large language model using an upside-down reinforcement learning method are provided with reference to FIG. 13.

FIG. 11 shows an example of an intent model 1100 according to aspects of the present disclosure. In one aspect, intent model 1100 includes input prompt 1105, synthetic image 1110, text encoder 1115, image encoder 1120, final representation 1125, and transformer network 1130.

An embodiment of the present disclosure includes an intent model 1100 configured to support unimodal input and multimodal input. In some cases, the intent model 1100 is able to understand an intent of long input text as well as short input text. For example, the intent model 1100 comprises a single embedding space for each node type (e.g., in a creative knowledge graph-CKG graph).

In some cases, intent model 1100 comprises a modified contrastive language-image pre-training (CLIP) model, i.e., a representation learning architecture (instead of a classification architecture) based on removing modality-wise attention and multilayer perceptron heads of the CLIP model. Additionally, intent model 1100 includes sequence-wise attention block. In some cases, the sequence-wise attention block takes as input the hidden states from the last layer of the CLIP backbone model that runs through a plurality of layers of transformer network 1130. For example, the transformer network 1130 comprises multi-headed transformer blocks.

In some cases, the intent model 1100 utilizes the T_{cls} and I_{cls} outputs from the sequence-wise attention heads as the final representation of the input image (such as synthetic image 1110) and text modalities (such as input prompt 1105). Synthetic image 1110 is an example of, or includes aspects of, the corresponding element described with reference to FIGS. 3 and 5.

In some cases, a loss function is computed to ensure that the synthetic image 1110 and input prompt 1105 in the training process is similar to the label embeddings. In some cases, the intent model 1100 is based on the loss function that is able to handle multiple positives in a batch, i.e., the loss function provides for multiple rows with the same label to be present in a batch when learning alignment with labels. In some cases, the intent model 1100 is based on the loss function that is able to include multiple labels per row, e.g., the intent model is able to understand multiple concepts such as creative intent “father's day”, scene objects “boy” and “beach”, and background “beach background” in a prompt “the boy is sitting on a beach with his dad for father's day”.

The loss function of the intent model 1100 is label-aligned supervised contrastive loss function where the image, text, and label embeddings are passed as anchor features and contrast features. Each row includes multiple label embeddings. In some cases, the label embeddings are used to create a positive mask which is used in cross-entropy calculation to not penalize multiple positives in a batch.

By using image, text, and label embeddings as both anchor and contrast features, the intent model is able to provide for each of the image, text, and label embeddings to be brought close to each other in the embedding space, i.e., zᵢ∈{θ_{labels}, θ_{image}, θₜₑₓₜ}.

$${ℒ}^{sup} = {\sum }_{i ∈ I} {ℒ}_{i}^{sup} = {\sum }_{i ∈ I} \frac{- 1}{P ( i )} {\sum }_{p ∈ P ( i )} [ {\sum }_{v ∈ j ( p )} log \frac{exp ( {z}_{i} \cdot {z}_{v} / τ )}{{\sum }_{n ∈ A ( i )} exp ( {z}_{i} \cdot {z}_{n} / τ )} ] \qquad ( 3 )$$

where I refers to a mini-batch, i refers to an index of anchor sample in the batch. A(i)−I{i}, i.e., each sample in the batch includes a distinct label (negatives) than the anchor i. p∈A₍ᵢ₎: yₚ=yᵢ, i.e., the set of indices of each positive sample in the batch that includes a distinct label y from the label of anchor i. v represents an element in the set j(p) of each positive sample p in the batch that includes the same label as anchor i, and are views of the anchor sample i. In some cases, v provides for label awareness by anchoring a multimodal sample (encoded as {θ_{image}, θₜₑₓₜ} over the discretized CKG node embeddings θ_{labels}.

FIG. 12 shows an example of a conventional reinforcement learning training pipeline 1200. In one aspect, conventional reinforcement learning training pipeline 1200 includes input 1205, diffusion model 1210, reward model 1215, KL loss 1220, and reference diffusion model 1225.

Referring to FIG. 12, a typical reinforcement learning mechanism, at training time for each text-image training pair (e.g., input 1205) for an image generation model (e.g., diffusion model/policy model 1210), will compute a reward on generated image 1230 and then attempt to backpropagate the reward using reinforcement learning mechanisms. Doing so requires an additional copy of an image generation model (e.g., reference diffusion model 1225) to be loaded in memory for KL divergence (e.g., KL loss 1220). Conventional reinforcement learning training pipeline 1200 also requires reward model 1215, which runs inference on each generated image 1230 to provide a reward metric.

By contrast, aspects of the present disclosure modify an input text condition directly using a training objective text (e.g., a “reward”) and therefore does not use a reinforcement learning algorithm to finetune the language model, and therefore, neither a reward model nor a reference model are used at training time. In some cases, by encoding an augmented training prompt using an encoder comprising a large language model having a semantic understanding of the augmented training prompt to obtain a training text embedding, a reward type is therefore defined and made part of an input condition for the language model that provides sufficient context to the language model for training and generating text that reflect the reward specified at inference time.

FIG. 13 shows an example of an upside down reinforcement learning process 1300 according to aspects of the present disclosure. Particularly, FIG. 13 shows an example of obtaining an asset generation prompt based on a training asset generation prompt according to aspects of the present disclosure. The example shown includes upside down reinforcement learning process 1300, training asset generation intent 1320, training asset generation prompt 1325, training objective text 1330, intermediate prompt 1335, first text embedding 1340, second text embedding 1345, and asset generation prompt 1350. First text embedding 1340 and second text embedding 1345 are an example of, or include aspects of, the corresponding elements described with reference to at least FIG. 5.

Upside down reinforcement learning process 1300 is an example of, or includes aspects of, the corresponding element described with reference to FIGS. 5 and 9-10. In one aspect, upside down reinforcement learning process 1300 includes first text encoder 1305, second text encoder 1310, and language model 1315. Text encoders 1305 and 1310 are an example of, or includes aspects of, an encoder described with reference to FIGS. 5 and 9-10. Language model 1315 is an example of, or includes aspects of, the corresponding element described with reference to FIGS. 5 and 9-10.

Referring to FIG. 13, training objective text 1330 is obtained based on training asset generation prompt 1325. In some cases, a user manually provides training objective text 1330. In some cases, a classifier model outputs training objective text 1330 based on training asset generation prompt 1325. For example, in some cases, the classifier model analyzes training asset generation prompt 1325 to determine a level of a target characteristic included in training asset generation prompt 1325. In some cases, the classifier model outputs objective text 1330 based on a result of the analysis, where objective text 1330 includes an indication of the determined level of the target characteristic. In some cases, a large language model (such as the large language model described with reference to FIG. 10) outputs training objective text 1330 based on an output provided by the classifier model based on training asset generation prompt 1325.

In some cases, a training component (such as the training component described with reference to FIGS. 10 and 17) generates training prompt by adding training objective text 1330 to asset generation intent 1320 of training asset generation prompt 1325. In some cases, first text encoder 1305 generates first text embedding 1340 based on intermediate prompt 1335. In some cases, second text encoder 1310 generates second text embedding 1345 based on training asset generation prompt 1325. In some cases, language model 1315 generates asset generation prompt 1350 based on first text embedding 1340, second text embedding 1345, or a combination thereof. In some cases, training component compares asset generation prompt 1350 to training asset generation prompt 1325 to calculate a loss using a loss function.

A loss function refers to a function that impacts how a machine learning model is trained in a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples. In some cases, the training component updates image generation parameters of image generation model 2015 based on the loss.

FIG. 14 shows an example of a method of training a machine learning model according to aspects of the present disclosure. FIG. 14 is a flow diagram depicting an algorithm as a step-by-step procedure 1400 in an example implementation of operations performable for training a machine-learning model. In some embodiments, the procedure 1400 describes an operation of the training component 1725 described for configuring the machine learning model 1715 as described with reference to FIG. 17. The procedure 1400 provides one or more examples of generating training data, use of the training data to train a machine-learning model, and use of the trained machine-learning model to perform a task.

To begin in this example, a machine-learning system collects training data (block 1402) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1410). The loss function is utilized to measure a difference between an output of the machine-learning model (i.e., predictions) and target values (e.g., as expressed by the training data) to be used to train the machine-learning model. Additionally, an optimization algorithm is selected (1412) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1414) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1420), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), the procedure 1400 continues training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore once trained is configured to perform that task based on subsequent data received as an input and processed by the machine-learning model. The machine learning model, is an example of, or includes aspects of, the intent model, language model, and image generation model described with reference to FIGS. 2, 5-8, 11-13, 15, and 17-18.

FIG. 15 shows an example of a method of training a diffusion model 1500 according to aspects of the present disclosure. In some embodiments, the method 1500 describes an operation of the training component 1725 described for configuring the machine learning model 1715 as described with reference to FIG. 17. The method 1500 represents an example for training a reverse diffusion process as described above with reference to FIGS. 6-8. In some examples, these operations are performed by a system including a processor executing a set of codes to control functional elements of an apparatus, such as the guided diffusion model described in FIG. 6.

Additionally or alternatively, certain processes of method 1500 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 15, according to some aspects, a training component (such as the training component 1725 described with reference to FIG. 17) trains a diffusion model (such as the image generation model described with reference to FIGS. 5 and 18) to generate an output.

At operation 1505, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1510, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 15.

At operation 1515, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1525, the system updates parameters of the model based on the comparison. For example, parameters of a U-Net may be updated using gradient descent. Time-dependent parameters of the Gaussian transitions can also be learned.

Accordingly, a method for training a machine learning model is described. One or more aspects of the method include obtaining a training set including an asset generation intent and an asset generation prompt; combining the asset generation intent and the asset generation prompt to obtain an intermediate prompt; and training, using the training set, the language model to generate the asset generation prompt based on the intermediate prompt.

Some examples of the method, apparatus, and non-transitory computer readable medium further include training the language model comprises: performing upside-down reinforcement learning. Some examples of the method, apparatus, and non-transitory computer readable medium further include training the language model comprises: distilling a teacher model, wherein the language model comprises fewer parameters than the teacher model.

In some aspects, the intermediate prompt comprises an intent tag. In some aspects, the intermediate prompt comprises a target prompt length based on a length of the asset generation prompt. In some aspects, the intermediate prompt comprises an asset category tag indicating an asset category corresponding to the asset generation prompt.

Some examples of the method, apparatus, and non-transitory computer readable medium further include training the language model comprises: computing a loss function based on the asset generation prompt. Some examples further include updating parameters of the language model based on the loss function.

### Implementation and Evaluation

An exemplary embodiment of the present disclosure includes a machine learning model configured to receive an input prompt and generate a multimodal asset based on the input prompt. In some cases, the machine learning model comprises an intent model such as Adobe® MINT (multimodal intent understanding), a language model such as a nanoGPT, and an image generation model such as Adobe® Firefly.

According to an exemplary embodiment, the language model has 104 million parameters that are able to fit in a graphics processing unit (GPU) of any size. In some cases, the inference efficiency of the language model is benchmarked. For example, the inference speed for asset generation prompt is 338 tokens per second using a high-performance GPU (e.g., a10g) with non-batched instances. In some examples, the inference speed is obtained without implementation of techniques such as quantization and on a 32-bit inference. Additional GPUs or batched methods are added to obtain high efficiency. In some cases, the same language model is used to generate an asset generation prompt for image generation and template generation for an asset generation intent.

According to an example, the asset generation prompt generated by the language model includes a controlled length, e.g., the asset generation prompt depicts a controlled generation in 10-35 words with minor variation (e.g., one- or two-words difference). For example, the generated (intent, prompt) pair is formatted as: “<|# words of the prompt|> <|intent|> INTENT <|prompt for T2I (IP) or T2T (TP)|> PROMPT” to train the language model.

In some cases, the machine learning model is able to control the prompt generation by the special tokens <|# words from 1 to 99|>, <|IP|>, and <|TP|>. By providing sufficient training data, the language model can support text-to-image generation and text-to-template prompt generation and controlled-length generation. According to an example, the language model is able to able to provide precisely controlled-length generation from 10 to 35 words, i.e., the mean squared error of the specified and actual lengths are 0˜2 indicating that the generation is precise (e.g., one- or two-words difference).

According to an exemplary embodiment, the training component is used to train a byte pair encoding (BPE) tokenizer of 25,600 tokens. Additionally, the training component trains the language model based on the model configurations (i.e., n_layer=12, n_head=12, n_embd=768, block_size=128), training configurations (i.e., batch_size=128, max_learning_rate=6e-4, weight_decay=0.1), and hardware (i.e., 1˜3 days on 4*a10g).

An exemplary embodiment of the present disclosure is configured to perform a quantitative evaluation and a qualitative evaluation of the asset generation prompt. In case of the qualitative evaluation, an evaluator scores the relevance between an input prompt (e.g., a source canvas) and the synthetic asset. Additionally, the evaluator scores the asset generation prompt for accuracy. The asset generation prompts indicated 87% relevancy and 74% accuracy.

In case of the quantitative evaluation, a large language model (e.g., GPT-4o) performs unimodal evaluation. The large language model (e.g., GPT-4o) is prompted for scoring the asset generation prompts. For example, the large language model (e.g., GPT-4o) is provided a concept (e.g., “Task description”) and an evaluation prompt (e.g., “Generate a score out of 10 based on the prompt provided. The score should reflect the quality of alignment with the given query”). Additionally, the large language model (e.g., GPT-4o) is provided another concept (e.g., “Query”) and an associated evaluation prompt (e.g., “For example, given the query <query>”). Similarly, the large language model (e.g., GPT-4o) is provided a concept (e.g., “Prompt metrics”) and an evaluation prompt (e.g., “ . . . . Score: 8.0; Prompt: generate a playful golden retriever puppy playing with a ball in a sunlit garden; Explanation: This prompt is more detailed, specifying the breed, activity, and setting . . . ; Score: 9.0; Prompt: create a group of different dog breeds playing together in a colorful autumn forest; Explanation: This prompt introduces variety with multiple dog breeds and a specific, visually appealing setting . . . ”).

The unimodal evaluation by the large language model (e.g., GPT-4o) indicates high relevance between the input prompt and the asset generation prompt of the present disclosure. The high relevance score indicates effective knowledge distillation of the large language model to the language model of the present disclosure.

In case of the quantitative evaluation, a large language model (e.g., GPT-4o) performs multimodal evaluation. In some cases, the large language model (e.g., GPT-4o) is prompted for scoring the asset generation prompts. For example, the large language model (e.g., GPT-4o) is provided a concept (e.g., “Task description”) and a different evaluation prompt (e.g., “You will be given some prompts. Your task is to look at the prompts and assign a score from 0-10 to each prompt, where 0 being irrelevant and 10 being very relevant. You are good at this and can do it. Please make sure you read and understand these instructions carefully. Please keep this document open while reviewing and refer to it as needed. The document consists of both the text (can be empty) and image. Steps: 1. You've been provided the document text and image. Read Document text and interpret image carefully. 2. Read the provided items carefully. 3. Assign a relevance score to each prompt from 0-10. A relevant prompt should be useful for text-to-image generative models, stick to the given text, and align to the main theme of the image. Moreover, it should incorporate specific elements from the image, encourage creativity and diversity, and use positive and dynamic language. 4. Do not provide the reason how you decide the score of the prompt. 5. VERY IMPORTANT-Only rank from the items provided, do NOT add any item on your own. 6. The output format should strictly be a json. 7. Be very consistent in your responses. you can do this.”).

Additionally, the large language model (e.g., GPT-4o) is provided another concept (e.g., “Example (input)”) and an associated evaluation prompt (e.g., “‘text’: “LEARN TO CODE”; Fun ways to learn to code website, apps, games, and more.; Teacher: Ernesto; Student: Any kids ages 8-15; Time: Thursday 7-8 PM; Address: community center””). Similarly, the large language model (e.g., GPT-4o) is provided another concept (e.g., “Example (output)”) and an associated evaluation prompt (e.g., “‘prompts’: [“Generate an image of a peaceful beach with palm trees and a sunset.”, “Illustrate a bustling cityscape at night with skyscrapers and neon lights.”, “Show a group of children playing soccer in a park on a sunny day.”, “Depict a classroom with students learning from a teacher using a whiteboard.”, “Create an image of kids aged 8-15 doing a science experiment in a lab.”, “Illustrate a group of children aged 8-15 playing educational games on tablets.”, “Show diverse kids aged 8-15 learning about technology with a teacher.”, “Depict children aged 8-15 coding on laptops at a community center.”, “Illustrate a group of kids aged 8-15 learning to code with a teacher at a community center, using laptops and tablets.”, “Show diverse kids aged 8-15 excitedly coding on laptops and tablets at a vibrant community center, with a teacher guiding them.”, “Create a vibrant scene of diverse children aged 8-15 learning to code at a community center, using laptops and tablets, guided by a teacher. Highlight excitement, collaboration, and colorful coding-themed decorations.”]”). The large language model (e.g., GPT-4o) is provided another concept (e.g., “Example (eval)”) and an evaluation prompt (e.g., ““scores”: [0, 1, 2, 3, 4, 5, 6, 7, 8, 9, 10]”).

The multimodal evaluation by the large language model (e.g., GPT-4o) indicates high relevance between the input prompt and the asset generation prompt of the present disclosure. The high relevance score indicates effective knowledge distillation of the large language model to the language model of the present disclosure. For example, the language model of the present disclosure is based on a 100 million parameter model (i.e., compared to 8 billion parameters of the large language model).

### Computing Device

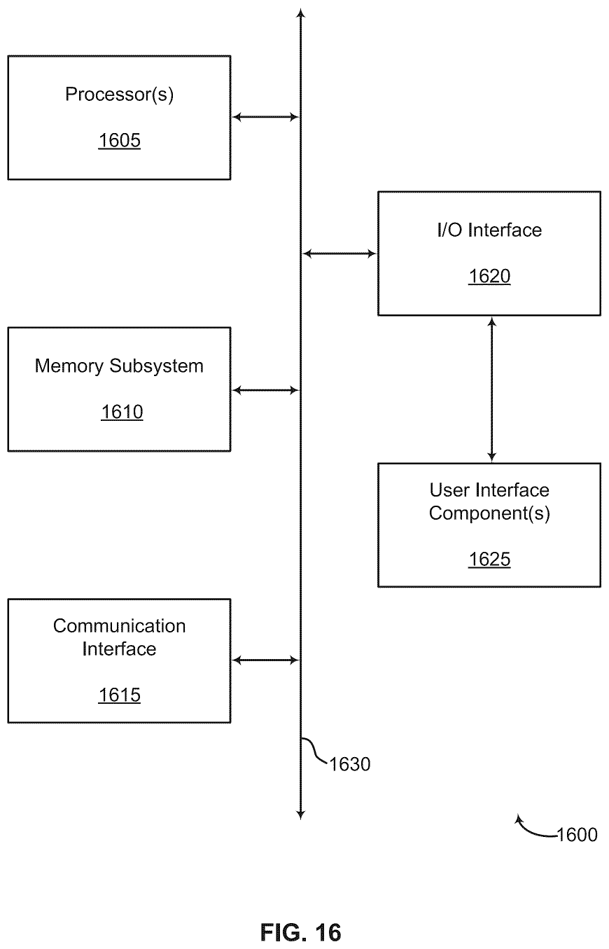

FIG. 16 shows an example of a computing device according to aspects of the present disclosure. The computing device 1600 may be an example of the multimedia processing apparatus 1700 described with reference to FIG. 17. In one aspect, computing device 1600 includes processor(s) 1605, memory subsystem 1610, communication interface 1615, I/O interface 1620, user interface component(s) 1625, and channel 1630.

In some embodiments, computing device 1600 is an example of, or includes aspects of, the machine learning model of FIGS. 17-18. In some embodiments, computing device 1600 includes one or more processors 1605 that can execute instructions stored in memory subsystem 1610 to perform media generation.

According to some aspects, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some aspects, user interface component(s) 1625 enable a user to interact with computing device 1600. In some cases, user interface component(s) 1625 include an audio device, such as an external speaker system, an external display device such as a display screen, an input device (e.g., a remote-control device interfaced with a user interface directly or through the I/O controller), or a combination thereof. In some cases, user interface component(s) 1625 include a GUI.

FIG. 17 shows an example of a multimedia processing apparatus 1700 according to aspects of the present disclosure. Multimedia processing apparatus 1700 is an example of, or includes aspects of, the corresponding element described with reference to FIGS. 1 and 3-4. According to some aspects, multimedia processing apparatus 1700 obtains an input prompt corresponding to a target element.

In one aspect, multimedia processing apparatus 1700 includes processor unit 1705, memory unit 1710, I/O module 1720, and training component 1725. Training component 1725 updates parameters of the machine learning model 1715 stored in memory unit 1710. In some examples, the training component 1725 is located outside the multimedia processing apparatus 1700.

According to some aspects, processor unit 1705 comprises a processing device coupled to the memory component. Processor unit 1705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1705 is configured to operate a memory array using a memory controller. In other cases, a memory controller is integrated into processor unit 1705. In some cases, processor unit 1705 is configured to execute computer-readable instructions stored in memory unit 1710 to perform various functions. In some aspects, processor unit 1705 includes special purpose components for modem processing, baseband processing, digital signal processing, or transmission processing. According to some aspects, processor unit 1705 comprises one or more processors described with reference to FIG. 16.

Memory unit 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1705 to perform various functions described herein.

In some cases, memory unit 1710 includes a basic input/output system (BIOS) that controls basic hardware or software operations, such as an interaction with peripheral components or devices. In some cases, memory unit 1710 includes a memory controller that operates memory cells of memory unit 1710. For example, the memory controller may include a row decoder, column decoder, or both. In some cases, memory cells within memory unit 1710 store information in the form of a logical state. According to some aspects, memory unit 1710 is an example of the memory subsystem 1610 described with reference to FIG. 16.

According to some aspects, multimedia processing apparatus 1700 uses one or more processors of processor unit 1705 to execute instructions stored in memory unit 1710 to perform functions described herein. For example, the multimedia processing apparatus 1700 may obtain an input prompt corresponding to a target element; generate, using an intent model, an asset generation intent based on the input prompt, wherein the asset generation intent indicates the target element; generate, using a language model, an asset generation prompt based on the asset generation intent, wherein the asset generation prompt describes the target element; and generate, using an image generation model, a synthetic asset depicting the target element based on the asset generation prompt.

In one aspect, memory unit 1710 includes machine learning model 1715 trained to obtain an input prompt corresponding to a target element; generate, using an intent model, an asset generation intent based on the input prompt, wherein the asset generation intent indicates the target element; generate, using a language model, an asset generation prompt based on the asset generation intent, wherein the asset generation prompt describes the target element; and generate, using an image generation model, a synthetic asset depicting the target element based on the asset generation prompt.

For example, after training, the machine learning model 1715 may perform inferencing operations as described with reference to FIGS. 1-3 to obtain an input prompt corresponding to a target element; generate, using an intent model, an asset generation intent based on the input prompt, wherein the asset generation intent indicates the target element; generate, using a language model, an asset generation prompt based on the asset generation intent, wherein the asset generation prompt describes the target element; and generate, using an image generation model, a synthetic asset depicting the target element based on the asset generation prompt.

Machine learning model 1715 is an example of, or includes aspects of, the corresponding element described with reference to FIGS. 3-4. In some embodiments, the machine learning model 1715 is an Artificial neural network (ANN) comprising a plurality of networks including the guided diffusion model described with reference to FIG. 6 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1715 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1725 may train the machine learning model 1715. For example, parameters of the machine learning model 1715 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 12-13). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1715 can be used to make predictions on new, unseen data (i.e., during inference).

According to some aspects, training component 1725 obtains a training set including an asset generation intent and an asset generation prompt. In some examples, training component 1725 combines the asset generation intent and the asset generation prompt to obtain an intermediate prompt. In some examples, training component 1725 trains, using the training set, the language model to generate the asset generation prompt based on the intermediate prompt.

According to some aspects, training component 1725 performs an upside-down reinforcement learning. According to some aspects, training component 1725 distills a teacher model, wherein the language model comprises fewer parameters than the teacher model.

According to some aspects, training component 1725 computes a loss function based on the asset generation prompt. In some examples, training component 1725 updates parameters of the language model based on the loss function.

I/O module 1720 receives inputs from and transmits outputs of the multimedia processing apparatus 1700 to other devices or users. For example, I/O module 1720 receives inputs for the machine learning model 1715 and transmits outputs of the machine learning model 1715. According to some aspects, I/O module 1720 is an example of the I/O interface 1620 described with reference to FIG. 16.

FIG. 18 shows an example of a machine learning model 1800 according to aspects of the present disclosure. In one aspect, machine learning model 1800 includes intent model 1805, language model 1810, and image generation model 1815. Intent model 1805 is an example of, or includes aspects of, the corresponding element described with reference to FIG. 11.

According to some aspects, intent model 1805 generates an asset generation intent based on an input prompt, where the asset generation intent indicates the target element. In some aspects, the asset generation intent includes a set of categorized intent terms including a topic intent, a background intent, an action intent, a scene intent or a combination thereof. Intent model 1805 is an example of, or includes aspects of, the corresponding element described with reference to FIG. 11.

According to some aspects, language model 1810 generates an asset generation prompt based on the asset generation intent, where the asset generation prompt describes the target element. In some examples, language model 1810 generates the asset generation prompt including determining an intermediate prompt including the asset generation intent and an intent tag, where the asset generation prompt is generated based on the intermediate prompt. In some examples, language model 1810 generates the asset generation prompt including determining an intermediate prompt including a target prompt length, where the asset generation prompt is generated based on the intermediate prompt.

In some examples, language model 1810 generates the asset generation prompt including determining an intermediate prompt including an asset category tag, where the asset generation prompt is generated based on the intermediate prompt, and where the synthetic asset includes an asset category corresponding to the asset category tag. In some aspects, the language model 1810 is trained using upside-down reinforcement learning based on a training intermediate prompt that includes a training asset generation intent and a training asset generation prompt.

According to some aspects, language model 1810 combines the asset generation intent and the asset generation prompt to obtain an intermediate prompt. In some aspects, the intermediate prompt includes an intent tag. In some aspects, the intermediate prompt includes a target prompt length based on a length of the asset generation prompt. In some aspects, the intermediate prompt includes an asset category tag indicating an asset category corresponding to the asset generation prompt.

According to some aspects, language model 1810 is comprising parameters stored in the at least one memory component and trained to generate an asset generation prompt for generating a synthetic asset based on an asset generation intent. In some aspects, the language model 1810 is trained using upside-down reinforcement learning. In some aspects, the language model 1810 is trained by distilling a teacher model.

According to some aspects, image generation model 1815 generates a synthetic asset depicting the target element based on the asset generation prompt. In some aspects, the synthetic asset includes a multimodal asset including a synthetic image depicting the target element and a text element. According to some aspects, image generation model 1815 is configured to generate the synthetic asset depicting based on the asset generation prompt.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input prompt corresponding to a target element;
generating, using an intent model, an asset generation intent based on the input prompt, wherein the asset generation intent indicates the target element;
generating, using a language model, an asset generation prompt based on the asset generation intent, wherein the asset generation prompt describes the target element; and
generating, using an image generation model, a synthetic asset depicting the target element based on the asset generation prompt.

2. The method of claim 1, wherein:
the input prompt comprises a multimodal asset including a text element and an image element.

3. The method of claim 1, wherein:
the asset generation intent comprises a plurality of categorized intent terms including a topic intent, a background intent, an action intent, a scene intent or a combination thereof.

4. The method of claim 1, wherein generating the asset generation prompt comprises:
determining an intermediate prompt including the asset generation intent and an intent tag, wherein the asset generation prompt is generated based on the intermediate prompt.

5. The method of claim 1, wherein generating the asset generation prompt comprises:
determining an intermediate prompt including a target prompt length, wherein the asset generation prompt is generated based on the intermediate prompt.

6. The method of claim 1, wherein generating the asset generation prompt comprises:
determining an intermediate prompt including an asset category tag, wherein the asset generation prompt is generated based on the intermediate prompt, and wherein the synthetic asset comprises an asset category corresponding to the asset category tag.

7. The method of claim 1, wherein:
the synthetic asset comprises a multimodal asset including a synthetic image depicting the target element and a text element.

8. The method of claim 1, wherein:
the language model is trained using upside-down reinforcement learning based on a training intermediate prompt that includes a training asset generation intent and a training asset generation prompt.

9. A method of training a machine learning model, the method comprising:
obtaining a training set including an asset generation intent and an asset generation prompt;
combining the asset generation intent and the asset generation prompt to obtain an intermediate prompt; and
training, using the training set, a language model to generate the asset generation prompt based on the intermediate prompt.

10. The method of claim 9, wherein training the language model comprises:
performing upside-down reinforcement learning.

11. The method of claim 9, wherein training the language model comprises:
distilling a teacher model, wherein the language model comprises fewer parameters than the teacher model.

12. The method of claim 9, wherein:
the intermediate prompt comprises an intent tag.

13. The method of claim 9, wherein:
the intermediate prompt comprises a target prompt length based on a length of the asset generation prompt.

14. The method of claim 9, wherein:
the intermediate prompt comprises an asset category tag indicating an asset category corresponding to the asset generation prompt.

15. The method of claim 9, wherein training the language model comprises:
computing a loss function based on the asset generation prompt; and
updating parameters of the language model based on the loss function.

16. An apparatus comprising:
at least one processor;
at least one memory component coupled with the at least one processor;
a language model comprising parameters stored in the at least one memory component and trained to generate an asset generation prompt for generating a synthetic asset based on an asset generation intent.

17. The apparatus of claim 16, further comprising:
an intent model configured to generate the asset generation intent based on an input prompt.

18. The apparatus of claim 16, further comprising:
an image generation model configured to generate the synthetic asset depicting based on the asset generation prompt.

19. The apparatus of claim 16, wherein:
the language model is trained using upside-down reinforcement learning.

20. The apparatus of claim 16, wherein:
the language model is trained by distilling a teacher model.
